(19) United States
(12) Patent Application Publication
(10) Pub. No.: US 2010/0260393 A1
(43) Pub. Date: Oct. 14, 2010

(54) NAVIGATION GUIDE

(75) Inventor: Roel Truyen, Turnhout (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/746,244

(22) PCT Filed: Dec. 1, 2008
(86) PCT No.: PCT/IB08/55027

§ 371 Date: Jun. 4, 2010

(30) Foreign Application Priority Data
Dec. 7, 2007 (EP) 07122660.9

(51) Int. Cl. G06T 7/00

(52) U.S. Cl. 382/128

(57) ABSTRACT

The invention relates to a system (200) for displaying images comprised in a stack of images on a display, the system comprising a path unit (210) for updating path data for determining a next position of a lumen indicator for indicating a next lumen in a next image comprised in the stack of images, wherein updating the path data is based on a current position of a lumen indicator for indicating a current lumen in a current image comprised in the stack of images, an input unit (220) for receiving a user input for selecting a next image from the stack of images, an image unit (230) for selecting the next image from the stack of images for displaying on the display, based on the user input, and an indicator unit (240) for determining the next position of the lumen indicator based on the path data and user input. The user input for selecting the next image from the stack of images comprises an input for an intuitive navigation up and down the stack of images. Advantageously, the system (200) also allows inspecting images which do not comprise a current lumen, e.g., images based on slices of data located above colon flexures, because manual navigation allows viewing every image comprised in the stack of images.

### FIELD OF THE INVENTION

The invention relates to the field of visualizing a tubular structure, such as a colon or blood vessel, described by images comprised in a stack of images.

### BACKGROUND OF THE INVENTION

Navigation through large datasets comprising a stack of thin slices, each slice defining a 2-dimensional (2-D) image, is either manual slice-by-slice viewing or centerline-guided viewing. For example, in colon endoscopy, 2-D images computed from slices comprised in a stack of slices are used to detect suspicious lesions. Intuitive navigation through a stack of slices is done by manually browsing up and down through the stack of slices. The user can move the mouse up or down to navigate. By moving the mouse up, the user will be navigating up the stack of slices. By moving the mouse down, she/he will be navigating down the stack of slices. The problem with manual browsing is that it does not allow to keep track of the currently viewed lumen within the tubular structure, e.g., a colon, when a plurality of lumens of an examined tubular structure are visualized in the image. This can be seen in FIG. 1, schematically illustrating the colon, showing flexures, substantially vertical, and substantially horizontal segments of the colon. The labeled parts of the colon comprise rectum 1, sigmoid colon 2, descending colon 3, transverse colon 4, ascending colon 5, and caecum 6. A slice in the middle of the stack will comprise a lumen of the descending and of the ascending segment of the colon. Thus, when a physician has to interrupt an exam to perform another more urgent task, she/he may easily forget which lumen of the plurality of lumens shown on the displayed image she/he has been examining just before the reading of the images was interrupted. As a result, the physician may need to repeat a part or the whole of the exam.

Some systems use navigation along the centerline of the colon or another tubular structure. Here, too, the user can move the mouse up or down to navigate. By moving the mouse up, the user will navigate in one direction along the centerline, e.g., from rectum 1 to caecum 6 of the colon. While moving the mouse up, the slices scroll up or down the stack according to the local direction of the centerline. The currently viewed lumen may be indicated by an indicator displayed at the current position on the centerline. However, this way of navigation is counterintuitive. Also, it is difficult or impossible to inspect colon flexures because only slices comprising a point of the centerline can be viewed.

### SUMMARY OF THE INVENTION

It would be advantageous to have a system using the intuitive navigation up and down a stack of slices and capable of indicating the examined lumen of a tubular structure displayed in an image computed from a current slice. Hereinafter, each slice comprised in a stack of slices is referred to as an image computed from that slice.

To better address this issue, in an aspect of the invention, a system for displaying images comprised in a stack of images on a display is provided, the system comprising:

a path unit for updating path data for determining a next position of a lumen indicator for indicating a next lumen in a next image comprised in the stack of images, wherein updating the path data is based on a current position of a lumen indicator for indicating a current lumen in a current image comprised in the stack of images;

an input unit for receiving a user input for selecting a next image from the stack of images;

an image unit for selecting the next image from the stack of images for displaying on the display, based on the user input; and

an indicator unit for determining the next position of the lumen indicator based on the path data and user input;

wherein the user input for selecting the next image from the stack of images comprises an input for an intuitive navigation up and down the stack of images.

For example, in an embodiment, the input device may be a mouse or trackball controlling a pointer for displaying on the display. The user input is based on the movement of the mouse or trackball. When the mouse or trackball is moved in one direction, e.g., up, the next image from the stack of images is above the current image. When the mouse or trackball is moved in an opposite direction, e.g., down, the next image from the stack of images is below the current image. When the mouse or trackball is moved, e.g., substantially horizontally, the next image is identical to the current image. This way of navigating through a stack of images is very intuitive. Associating a first set of directions with moving up the stack of images and a second set of directions, typically a complementary set of directions opposite to the directions from the first set, with moving down the stack of images, enables navigating up and down the stack of images which is here referred to as “an intuitive navigation up and down the stack of images”. A person skilled in the art will know more implementations of intuitively navigating through a stack of images. The scope of the claims should not be construed as being limited by the described implementations.

On the other hand, the system enables displaying a lumen indicator in a displayed image retrieved from the stack of images. At the beginning of an examination, the first image for displaying on the display may be a predetermined image comprised in the stack of images, e.g., the image at the bottom of the stack, an image comprising a lesion in a blood vessel or the exit point of the rectum segment of the colon, or an image selected by a user. Similarly, the lumen indicator may be arranged to indicate a predetermined or user-selected lumen. In an embodiment, the position of the lumen indicator comprises a z-coordinate of the lumen, i.e., the index of the current image comprised in the stack of images and an x and y coordinate of the lumen indicator in the current image comprised in the stack of images. As the user moves along the tubular structure, which involves moving up and down the stack of images, the next position of the lumen indicator is based on the path data comprising, for example, a complete sequence of prior positions of the lumen indicator and, optionally, the time of determining each next lumen position. The path data may be updated synchronously, the act of updating being separated by identical-length time intervals, or asynchronously, after each user input. When the user selects the next image, the next position of the lumen indicator is determined based on the path data and user input, using an algorithm for computing the next position of the lumen indicator. The algorithm for computing the next position of the lumen indicator takes into account the path data to ensure that the lumen indicator moves in a direction intended by the user, e.g., to avoid indicating a lumen which has been already examined unless the user chooses to return to such a lumen. The next image and the lumen indicator at the next position are displayed on the display and become the current image and the lumen indicator at the current position. The current position and/or information derived from it is recorded in the path data and the system is ready for processing the next user input. Thus, the system of the invention enables indicating the examined lumen of the examined tubular structure. Advantageously, the system also allows inspecting images, which do not comprise a current lumen, e.g., images based on slices of data located above colon flexures, because manual navigation allows viewing every image comprised in the stack of images.

In an embodiment of the system, the next position of the lumen indicator is further based on a predefined guideline located inside the lumen. Such a guideline is very helpful to implement determining the next position of the lumen indicator. The next position of the lumen indicator may be defined as a point where the guideline, e.g., the centerline, crosses the next image.

In an embodiment, the system further comprises a profile unit for displaying a profile of the predefined guideline and for displaying a complementary lumen indicator on the profile of the guideline. The profile of the guide-line, e.g., of the centerline, displays the complementary lumen indicator for visualizing a third coordinate of the lumen indicator, e.g., the z-coordinate, i.e., the index of the current image comprised in the stack of images, thus allowing the user to relate the current image and the examined lumen to the examined tubular structure as a whole.

In an embodiment of the system, the user input for selecting the next image from the stack of images further comprises an input for selecting the next position of the lumen indicator independently of the next image. For example, the vertical component of a mouse pointer displacement vector may be used for selecting the next image from the stack of images and the horizontal component of said vector may be used for determining the position of the lumen indicator. Thus, the user has full control of navigating through a tubular structure, e.g., through a colon from the descending segment via the transverse segment to the ascending segment shown in FIG. 1.

In an embodiment, the system is used for virtual colonoscopy, the system further comprising a prone-supine unit for computing the image based on registering prone and supine image data. CT virtual colonoscopy is a technique for detecting polyps in the colon. Colon cancer is often preceded by the presence of a polyp before it becomes malignant. In order to detect polyps in an early stage, a minimally invasive CT scan is taken which allows the radiologist to detect clinically significant polyps. Currently most institutions perform two scans of the same patient: one in prone position (lying on her/his belly), and one in supine position (lying on her/his back). This is done to overcome any limitations associated with partial collapse or presence of residual fluid that will hamper the view in one position, but may be resolved in the other view. Knowing the exact viewing position along the centerline allows for accurate prone-supine matching of the two datasets.

In an embodiment of the system, the user input is visualized by a pointer for displaying on the display. While using a data input device such as a mouse gives the user sensory feedback on her/his input, the mouse pointer displayed on the display gives the user a visual feedback on her/his input.

In a further aspect of the invention, a method of displaying images comprised in a stack of images on a display is provided, the method comprising:

a path step for updating path data for determining a next position of a lumen indicator for indicating a next lumen in a next image comprised in the stack of images, wherein updating the path data is based on a current position of a lumen indicator for indicating a current lumen in a current image comprised in the stack of images;

an input step for receiving a user input for selecting a next image from the stack of images;

an image step for selecting the next image from the stack of images for displaying on the display, based on the user input; and

an indicator step for determining the next position of the lumen indicator based on the path data and user input;

wherein the user input for selecting the next image from the stack of images comprises an input for an intuitive navigation up and down the stack of images.

In a further aspect of the invention, a computer program product to be loaded by a computer arrangement is provided, the computer program product comprising instructions for displaying images comprised in a stack of images on a display, the computer arrangement comprising a processing unit and a memory, the computer program product, after being loaded, providing said processing unit with the capability to carry out the tasks of:

updating path data for determining a next position of a lumen indicator for indicating a next lumen in a next image comprised in the stack of images, wherein updating the path data is based on a current position of a lumen indicator for indicating a current lumen in a current image comprised in the stack of images;

receiving a user input for selecting a next image from the stack of images;

selecting the next image from the stack of images for displaying on the display, based on the user input; and

determining the next position of the lumen indicator based on the path data and user input;

wherein the user input for selecting the next image from the stack of images comprises an input for an intuitive navigation up and down the stack of images.

In a further aspect of the invention, the system according to the invention is comprised in an image acquisition apparatus.

In a further aspect of the invention, the system according to the invention is comprised in a workstation.

It will be appreciated by those skilled in the art that two or more of the above-mentioned embodiments, implementations, and/or aspects of the invention may be combined in any way deemed useful.

Modifications and variations of the image acquisition apparatus, of the workstation, of the method, and/or of the computer program product, which correspond to the described modifications and variations of the system, can be carried out by a person skilled in the art on the basis of the present description.

A person skilled in the art will appreciate that the method may be applied to 3-dimensional (3-D) or 4-dimensional (4-D) image data acquired by various acquisition modalities such as, but not limited to, standard X-ray Imaging, Computed Tomography (CT), Magnetic Resonance Imaging (MRI), Ultrasound (US), Positron Emission Tomography (PET), Single Photon Emission Computed Tomography (SPECT), and Nuclear Medicine (NM).

### BRIEF DESCRIPTION OF THE DRAWINGS

These and other aspects of the invention will become apparent from and will be elucidated with respect to the implementations and embodiments described hereinafter and with reference to the accompanying drawings, wherein:

FIG. 1 schematically illustrates the colon;

FIG. 2 schematically shows a block diagram of an exemplary embodiment of the system;

FIG. 3 shows two exemplary CT virtual colonoscopy current images and the corresponding two exemplary profiles of the colon centerline;

FIG. 4 illustrates an exemplary path of the lumen indicator;

FIG. 5 shows a flowchart of an exemplary implementation of the method;

FIG. 6 schematically shows an exemplary embodiment of the image acquisition apparatus; and

FIG. 7 schematically shows an exemplary embodiment of the workstation.

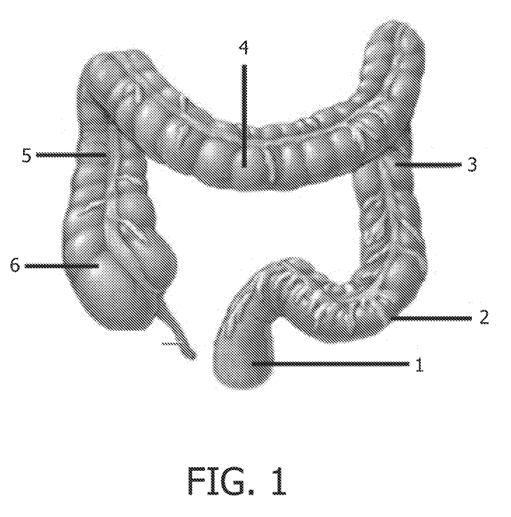

Identical reference numerals are used to denote similar parts throughout the Figures.

### DETAILED DESCRIPTION OF EMBODIMENTS

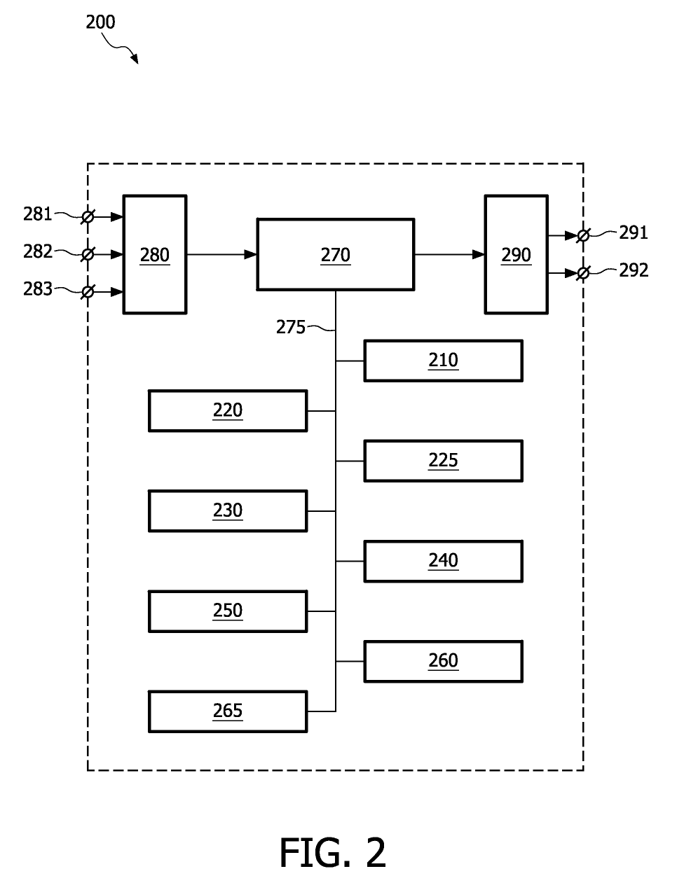

FIG. 2 schematically shows a block diagram of an exemplary embodiment of the system 200 for displaying images comprised in a stack of images on a display, the system comprising:

a path unit 210 for updating path data for determining a next position of a lumen indicator for indicating a next lumen in a next image comprised in the stack of images, wherein updating the path data is based on a current position of a lumen indicator for indicating a current lumen in a current image comprised in the stack of images;

an input unit 220 for receiving a user input for selecting a next image from the stack of images;

an image unit 230 for selecting the next image from the stack of images for displaying on the display, based on the user input; and

an indicator unit 240 for determining the next position of the lumen indicator, based on the path data and user input;

wherein the user input for selecting the next image from the stack of images comprises an input for an intuitive navigation up and down the stack of images.

The exemplary embodiment of the system 200 further comprises the following units:

a profile unit 225 for displaying a profile of the predefined guideline and for displaying a complementary lumen indicator on the profile of the guideline;

a prone-supine unit 250 for computing the image, based on registering prone and supine image data;

a control unit 260 for controlling the workflow in the system 200;

a user interface 265 for communicating with a user of the system 200; and

a memory unit 270 for storing data.

In an embodiment of the system 200, there are three input connectors 281, 282 and 283 for the incoming data. The first input connector 281 is arranged to receive data coming in from a data storage means such as, but not limited to, a hard disk, a magnetic tape, a flash memory, or an optical disk. The second input connector 282 is arranged to receive data coming in from a user input device such as, but not limited to, a mouse or a touch screen. The third input connector 283 is arranged to receive data coming in from a user input device such as a keyboard. The input connectors 281, 282 and 283 are connected to an input control unit 280.

In an embodiment of the system 200, there are two output connectors 291 and 292 for the outgoing data. The first output connector 291 is arranged to output the data to a data storage means such as a hard disk, a magnetic tape, a flash memory, or an optical disk. The second output connector 292 is arranged to output the data to a display device. The output connectors 291 and 292 receive the respective data via an output control unit 290.

A person skilled in the art will understand that there are many ways to connect input devices to the input connectors 281, 282 and 283 and the output devices to the output connectors 291 and 292 of the system 200. These ways comprise, but are not limited to, a wired and a wireless connection, a digital network such as, but not limited to, a Local Area Network (LAN) and a Wide Area Network (WAN), the Internet, a digital telephone network, and an analog telephone network.

In an embodiment, the system 200 comprises a memory unit 270. The system 200 is arranged to receive input data from external devices via any of the input connectors 281, 282, and 283 and to store the received input data in the memory unit 270. Loading the input data into the memory unit 270 allows quick access to relevant data portions by the units of the system 200. The input data may comprise, for example, a data set comprising the stack of images (i.e., slices). The memory unit 270 may be implemented by devices such as, but not limited to, a Random Access Memory (RAM) chip, a Read Only Memory (ROM) chip, and/or a hard disk drive and a hard disk. The memory unit 270 may be further arranged to store the output data. The output data may comprise, for example, the next image and the next position of the lumen indicator. The memory unit 270 may be also arranged to receive data from and/or deliver data to the units of the system 200 comprising the path unit 210, the input unit 220, the profile unit 225, the image unit 230, the indicator unit 240, the prone-supine unit 250, the control unit 260, and the user interface 265, via a memory bus 275. The memory unit 270 is further arranged to make the output data available to external devices via any of the output connectors 291 and 292. Storing data from the units of the system 200 in the memory unit 270 may advantageously improve performance of the units of the system 200 as well as the rate of transfer of the output data from the units of the system 200 to external devices.

Alternatively, the system 200 may comprise no memory unit 270 and no memory bus 275. The input data used by the system 200 may be supplied by at least one external device, such as an external memory or a processor, connected to the units of the system 200. Similarly, the output data produced by the system 200 may be supplied to at least one external device, such as an external memory or a processor, connected to the units of the system 200. The units of the system 200 may be arranged to receive the data from each other via internal connections or via a data bus.

In an embodiment, the system 200 comprises a control unit 260 for controlling the workflow in the system 200. The control unit may be arranged to receive control data from and provide control data to the units of the system 200. For example, after receiving a user input, the input unit 220 may be arranged to provide control data “user input received” to the control unit 260 and the control unit 260 may be arranged to provide control data “determine the next image” to the image unit 230, thereby requesting the image unit 230 to determine the next image. Alternatively, a control function may be implemented in another unit of the system 200.

In an embodiment, the system 200 comprises a user interface 265 for communicating with the user of the system 200. The user interface 265 may be arranged to provide data for displaying the next image. Optionally, the input unit 210 may be a sub-unit of the user interface 260. Optionally, the user interface may receive a user input for selecting a mode of operation of the system such as, e.g., for selecting a fully manual or semi-automatic mode of navigation through a tubular structure. A person skilled in the art will understand that more functions may be advantageously implemented in the user interface 265 of the system 200.

The embodiments of the invention will be illustrated using CT virtual colonoscopy, also referred to as CT colonography. A person skilled in the art will understand that the invention may be also applied to view images from a stack of images depicting another tubular structure, e.g., a blood-vessel segment.

The path unit 210 is arranged to update the path data for determining a next position of the lumen indicator. For example, the path unit 210 may be arranged to record a current position of the lumen indicator and, optionally, a time stamp indicating the time of determining or recording the current position of the lumen indicator. Hence, the path data may be organized as a sequence of current positions. In an asynchronous embodiment, the path unit 210 waits for a user input. After the system 200 receives a user input and computes the next image and the next position of the lumen indicator, the next position of the lumen indicator becomes the current position and is appended to the sequence of current positions. Optionally, each element of the sequence may also comprise a time of occurrence of the event—of receiving the user input. In a synchronous embodiment, the path unit is arranged to update the path data periodically.

The input unit 220 is arranged for receiving a user input. Typically, the user input is received from a user input device such as a mouse. However, any device which allows for implementing an intuitive navigation up and down the stack of images may be employed. Examples of such a device include, but are not limited to, a mouse, a mouse wheel, a trackball, a motion tracking device, and a light pen. The user input comprises an input for selecting the next image and is also used for determining the next position of the lumen indicator. A first set of directions may be associated with inputs for selecting the next image above the current image. A second set of directions, typically, the set of directions opposite to directions from the first set, may be associated with inputs for selecting the next image below the current image. Further, the user input may also be based on the displacement and/or on the speed of the displacement of a device such as the said mouse, mouse wheel, trackball, tracking device, or light pen. The user input may be read periodically, e.g., every 10 ms, or asynchronously, e.g., when the user provides the user input using the input device. In an embodiment, the user input is determined by the vertical displacement of the mouse. Every vertical displacement of the mouse up or down by, e.g., 5 mm, is received by the input unit. Based on this input, the image unit 230 is arranged to select the next image from the stack of images to be the image adjacent to the current image and, respectively, above or below the current image. When the user moves the mouse vertically by N mm, the image unit 230 interprets the mouse displacement as N/5 consecutive user inputs for selecting the next image. Alternatively, the image unit 230 may interpret the mouse displacement as one input to select the next image N/5 images above or below the current image.

The indicator unit 240 is arranged for using an algorithm to determine the next position of the lumen indicator. There are several ways of implementing the algorithm for determining the next position of the lumen indicator. In an embodiment, the next position of the lumen indicator is further based on a predefined guideline located inside the lumen. The guideline may be a user-designed guideline, e.g., a polyline or a Bezier curve controlled by user-selected control points inside the colon. Optionally, the guideline may be the colon centerline. The system may be arranged to receive the centerline data. For example, each image comprised in the stack of images may be associated with a set of coordinates of the centerline points comprised in the image. A skilled person will understand that some sets may comprise coordinates of a plurality of points, some sets may comprise coordinates of only one point, and some sets may be empty. Coordinates of a point comprised in a set of coordinates may correspond to a point where the centerline crosses the plane of the image associated with the set, or to a point where the centerline is tangent to the plane of the image associated with the set. Optionally, the system may be arranged to compute the centerline from the image data comprised in the stack of slices.

In an embodiment, the next position of the lumen indicator is computed asynchronously using the centerline of the colon. The next image is always an image adjacent to the current image. If the user wants to jump quickly over multiple images comprised in the stack of images, the user input is partitioned into a sequence of step-inputs, each step-input determining the next image adjacent to the current image. The path data comprises lumen traversal direction data. The lumen traversal direction data is determined by the most recent change of the position of the lumen indicator along the centerline in a plane perpendicular to the image stack axis. In the following algorithm for determining the next position of the lumen indicator, there are three situations to be taken into account.

If the current position (x₀, y₀, z₀) of the lumen indicator is connected to the next image plane by one segment of the centerline which does not cross any other image plane, the coordinates (x₁, y₁, z₁) of the end in the next image plane of this segment define the next position of the lumen indicator.

If the current position (x₀, y₀, z₀) of the lumen indicator is connected to the next image plane by two segments of the centerline which do not cross any other image plane, the coordinates (x₁, y₁, z₁) of the end in the next image plane of the segment in the lumen traversal direction data define the next position of the lumen indicator.

If the current position (x₀, y₀, z₀) of the lumen indicator is not connected to the next image plane by a segment of the centerline which does not cross any other image plane then coordinates of the next position of the lumen indicator are x₀, y₀ and the z-coordinate of the next image plane.

This simple algorithm allows the user to navigate forward along the centerline while using the intuitive manual navigation. The user may also easily navigate backward along the centerline.

A person skilled in the art will understand that this algorithm may be modified, e.g., by including time constraints in the rules to eliminate jitters or short involuntary hesitations. The described exemplary algorithm requires only the current position of the lumen indicator and the lumen traversal direction data, which may be represented by one bit, to determine the next position of the lumen indicator. Hence the path data may be very short. Those skilled in the art will understand that other implementations of the algorithm, e.g., implementations allowing the next image to be an image that is not adjacent to the current image or implementations based on the colon wall delineation, may be used by the system of the invention. Thus, the scope of the claims should not be construed as being limited by the described implementation of the algorithm for determining the next position of the lumen indicator.

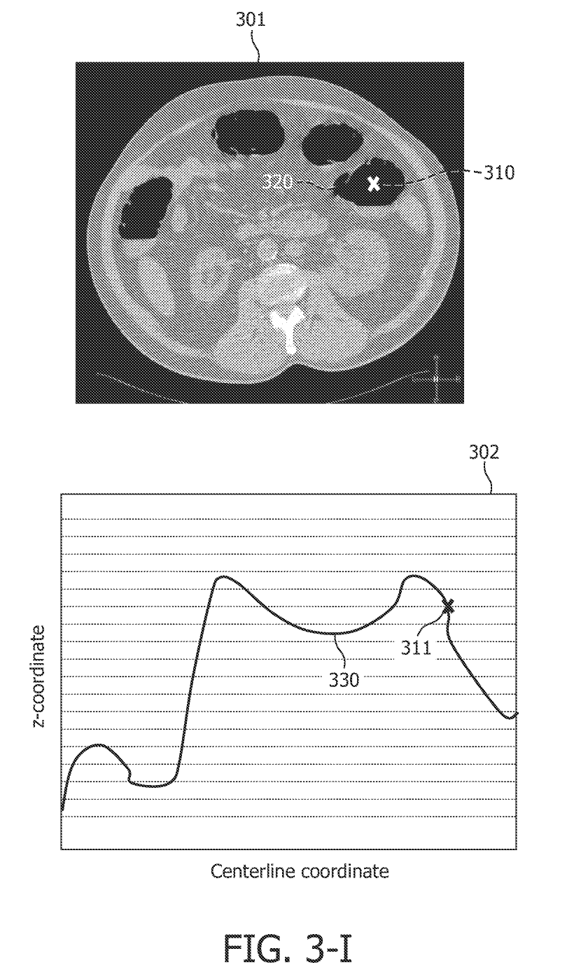

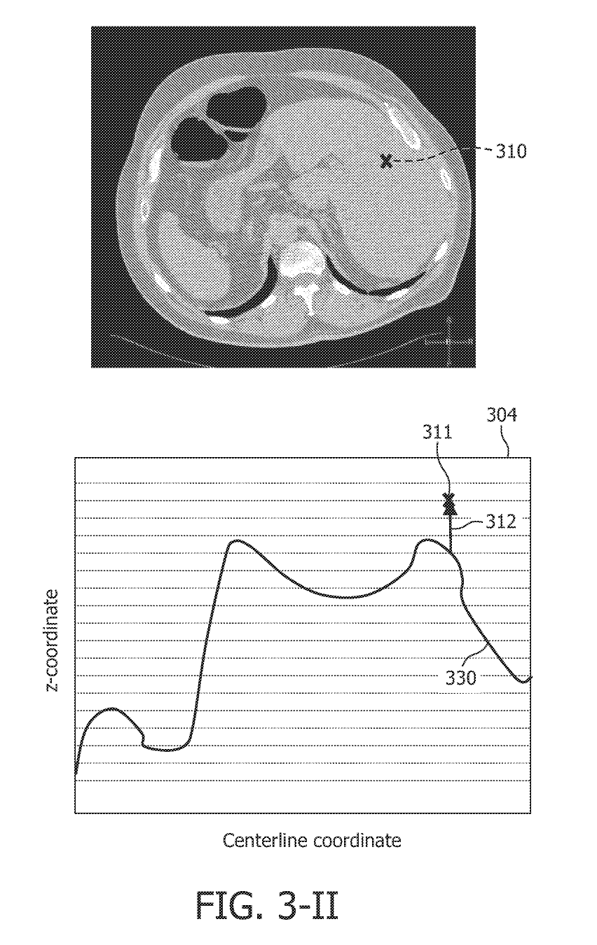

FIG. 3 shows two exemplary CT virtual colonoscopy current images and the corresponding two exemplary profiles of the colon centerline. The first exemplary current image 301 shows an exemplary lumen indicator 310. The exemplary lumen indicator 310 is a cross centered in the colon lumen 320, where the centerline crosses the plane of the current image 301, thereby indicating the lumen 320 in the current image 301. In an embodiment, the lumen 320 may be indicated by an arrow pointing at the center of the lumen 320. In a further embodiment, when the radius of the current lumen is known, the lumen 320 may be indicated by a circle encircling the lumen 320. After delineating the lumen in the current image, e.g., by region growing from the lumen 320 center, the lumen 320 may be indicated by coloring pixels of the lumen 320. A person skilled in the art will know more ways of indicating a lumen in an image.

A profile image 302 of the centerline of the colon shows a profile 330 of the centerline and the complementary lumen indicator 311, corresponding to the lumen indicator 310 shown in the current image 301. The complementary lumen indicator 311 indicates the location of the current image within the stack of images and along the centerline. The complementary lumen indicator 311 displayed on the profile of the colon centerline allows the user to relate the current image 301 to the examined structure. Hence, the user may easily conclude that the lumen indicator 310 in the image 301 points at a lumen in the descending segment of the colon.

In the second exemplary current image 303 in FIG. 3, the lumen indicator 310 does not indicate any colon lumen. This is because the image 303 shows a slice comprising data above the last examined descending segment of the colon. Optionally, the lumen indicator 310 in the current image 302 may be not displayed.

The situation shown in the second exemplary current image is further depicted in the profile image 304 of the profile 330 of the centerline of the colon showing the complementary lumen indicator 311. The vertical coordinate of the complementary lumen indicator corresponds to the z-coordinate, i.e., to the index of the current image within the stack of images. The horizontal coordinate indicates the last viewed point of the colon centerline, i.e., the point of the centerline viewed in a previous current image, before obtaining a user input for moving up the stack of images. Optionally, the secondary lumen indicator may comprise an arrow 312 from the last viewed point on the centerline to the position of the projection of this point on the current image plane.

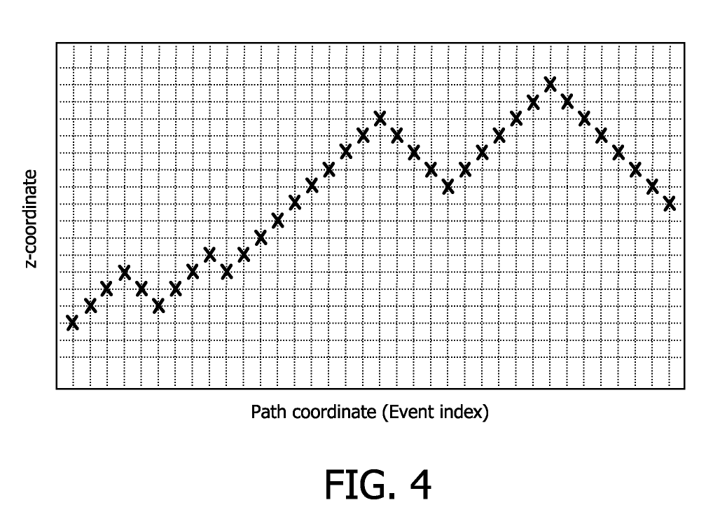

FIG. 4 illustrates an exemplary asynchronous path of the lumen indicator. The horizontal axis is the event index axis. Each event corresponds to receiving a user input. The vertical axis is the z-coordinate axis describing the stack axis, i.e., a slice index.

In an embodiment, the system is used for virtual colonoscopy, further comprising a prone-supine unit 250 for computing the image based on registering prone and supine image data. CT virtual colonoscopy is a technique for detecting polyps in the colon. Currently most institutions perform two scans of the same patient: one in prone position, and one in supine position. The centerlines of two scans can be aligned by locally stretching or compressing the centerlines so that they are as similar as possible. A method of registering prone and supine image data is described, e.g., in a patent application WO 2007/015187 A2 and in a paper “Intra-patient Prone to Supine Colon Registration for Synchronized Virtual Colonoscopy”, Delphine Nain et al., T. Dohi and R. Kikinis (Eds.): MICCAI 2002, LNCS 2489, pp. 573-580, 2002, Springer-Verlag Berlin Heidelberg 2002.

A person skilled in the art will appreciate that the system 200 may be a valuable tool for assisting a physician in many aspects of her/his job.

Those skilled in the art will further understand that other embodiments of the system 200 are also possible. It is possible, among other things, to redefine the units of the system and to redistribute their functions. Although the described embodiments apply to medical images, other applications of the system, not related to medical applications, are also possible.

The units of the system 200 may be implemented using a processor. Normally, their functions are performed under the control of a software program product. During execution, the software program product is normally loaded into a memory, like a RAM, and executed from there. The program may be loaded from a background memory, such as a ROM, hard disk, or magnetic and/or optical storage, or may be loaded via a network like the Internet. Optionally, an application-specific integrated circuit may provide the described functionality.

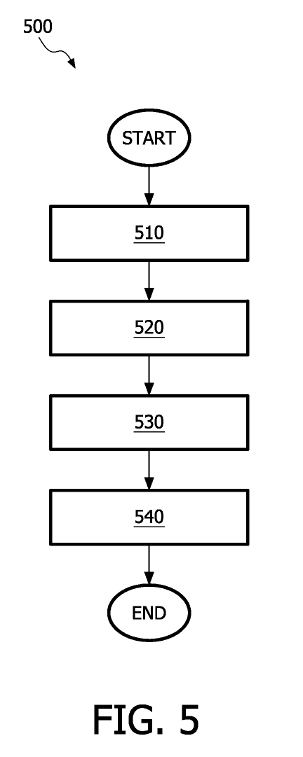

FIG. 5 shows a flowchart of an exemplary implementation of the method 500 of displaying images comprised in a stack of images on a display. The method 500 begins with a path step 510 for updating path data for determining a next position of a lumen indicator for indicating a next lumen in a next image comprised in the stack of images, wherein updating the path data is based on a current position of a lumen indicator for indicating a current lumen in a current image comprised in the stack of images. After the path step 510, the method 500 continues to an input step 520 for receiving a user input for selecting a next image from the stack of images. The user input for selecting the next image from the stack of images comprises an input for an intuitive navigation up and down the stack of images. After the input step 520, the method 500 continues to an image step 530 for selecting the next image from the stack of images for displaying on the display, based on the user input. After the image step 530, the method 500 continues to an indicator step 540 for determining the next position of the lumen indicator based on the path data and user input. After the indicator step 540, the method 500 terminates.

Those skilled in the art will understand that during an examination of the colon or another tubular structure, the steps of the method 500 will be followed by the step of replacing the current image and the current position of the lumen indicator with, respectively, the next image and the next position of the lumen indicator. Next, the updated current image and lumen indicator will be displayed and the steps of the method 500 may be executed again.

A person skilled in the art may change the order of some steps or perform some steps concurrently using threading models, multi-processor systems or multiple processes without departing from the concept as intended by the present invention. Optionally, two or more steps of the method of the current invention may be combined into one step. Optionally, a step of the method of the current invention may be split into a plurality of steps.

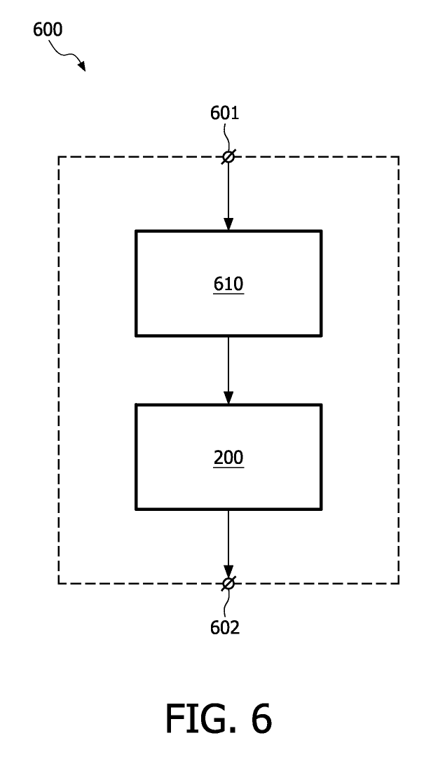

FIG. 6 schematically shows an exemplary embodiment of the image acquisition apparatus 600 employing the system 200, said image acquisition apparatus 600 comprising a CT image acquisition unit 610 connected via an internal connection with the system 200, an input connector 601, and an output connector 602. This arrangement advantageously increases the capabilities of the image acquisition apparatus 600, providing said image acquisition apparatus 600 with advantageous capabilities of the system 200.

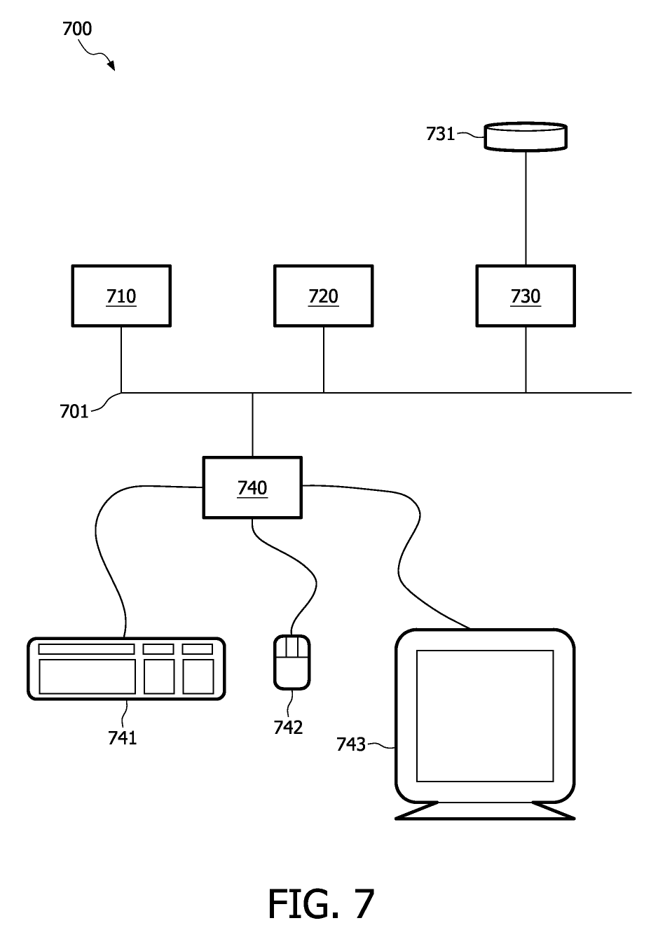

FIG. 7 schematically shows an exemplary embodiment of the workstation 700. The workstation comprises a system bus 701. A processor 710, a memory 720, a disk input/output (I/O) adapter 730, and a user interface (UI) 740 are operatively connected to the system bus 701. A disk storage device 731 is operatively coupled to the disk I/O adapter 730. A keyboard 741, a mouse 742, and a display 743 are operatively coupled to the UI 740. The system 200 of the invention, implemented as a computer program, is stored in the disk storage device 731. The workstation 700 is arranged to load the program and input data into memory 720 and execute the program on the processor 710. The user can input information to the workstation 700, using the keyboard 741 and/or the mouse 742. The workstation is arranged to output information to the display device 743 and/or to the disk 731. A person skilled in the art will understand that there are numerous other embodiments of the workstation 700 known in the art and that the present embodiment serves the purpose of illustrating the invention and must not be interpreted as limiting the invention to this particular embodiment.

It should be noted that the above-mentioned embodiments illustrate rather than limit the invention and that those skilled in the art will be able to design alternative embodiments without departing from the scope of the appended claims. In the claims, any reference signs placed between parentheses shall not be construed as limiting the claim. The word “comprising” does not exclude the presence of elements or steps not listed in a claim or in the description. The word “a” or “an” preceding an element does not exclude the presence of a plurality of such elements. The invention can be implemented by means of hardware comprising several distinct elements and by means of a programmed computer. In the system claims enumerating several units, several of these units can be embodied by one and the same item of hardware or software. The usage of the words first, second, third, etc., does not indicate any ordering. These words are to be interpreted as names.

1. A system (200) for displaying images comprised in a stack of images on a display, the system comprising:
a path unit (210) for updating path data for determining a next position of a lumen indicator for indicating a next lumen in a next image comprised in the stack of images, wherein updating the path data is based on a current position of a lumen indicator for indicating a current lumen in a current image comprised in the stack of images;
an input unit (220) for receiving a user input for selecting a next image from the stack of images;
an image unit (230) for selecting the next image from the stack of images for displaying on the display, based on the user input; and
an indicator unit (240) for determining the next position of the lumen indicator, based on the path data and user input;
wherein the user input for selecting the next image from the stack of images comprises an input for an intuitive navigation up and down the stack of images.

2. A system (200) as claimed in claim 1, wherein the next position of the lumen indicator is further based on a predefined guideline located inside the lumen.

3. A system (200) as claimed in claim 2, further comprising a profile unit (225) for displaying a profile of the predefined guideline and for displaying a complementary lumen indicator on the profile of the guideline.

4. A system (200) as claimed in claim 1, wherein the user input for selecting the next image from the stack of images further comprises an input for selecting the next position of the lumen indicator independently of the next image.

5. A system (200) as claimed in claim 1, used for virtual colonoscopy, further comprising a prone-supine unit (250) for computing the image based on registering prone and supine image data.

6. A system as claimed in claim 1, wherein the user input is visualized by a pointer for displaying on the display.

7. A method (500) of displaying images comprised in a stack of images on a display, the method comprising:
a path step (510) for updating path data for determining a next position of a lumen indicator for indicating a next lumen in a next image comprised in the stack of images, wherein updating the path data is based on a current position of a lumen indicator for indicating a current lumen in a current image comprised in the stack of images;
an input step (520) for receiving a user input for selecting a next image from the stack of images;
an image step (530) for selecting the next image from the stack of images for displaying on the display, based on the user input; and
an indicator step (540) for determining the next position of the lumen indicator based on the path data and user input;
wherein the user input for selecting the next image from the stack of images comprises an input for an intuitive navigation up and down the stack of images.

8. An image acquisition apparatus (600) comprising a system (200) as claimed in claim 1.

9. A workstation (700) comprising a system (200) as claimed in claim 1.

10. A computer program product to be loaded by a computer arrangement, comprising instructions for displaying images comprised in a stack of images on a display, the computer arrangement comprising a processing unit and a memory, the computer program product, after being loaded, providing said processing unit with the capability to carry out the tasks of:
updating path data for determining a next position of a lumen indicator for indicating a next lumen in a next image comprised in the stack of images, wherein updating the path data is based on a current position of a lumen indicator for indicating a current lumen in a current image comprised in the stack of images;
receiving a user input for selecting a next image from the stack of images;
selecting the next image from the stack of images for displaying on the display, based on the user input; and
determining the next position of the lumen indicator based on the path data and user input;
wherein the user input for selecting the next image from the stack of images comprises an input for an intuitive navigation up and down the stack of images.
